(19) United States
(12) Patent Application Publication
(10) Pub. No.: US 2017/0145732 A1
(43) Pub. Date: May 25, 2017

(54) Emergency Escape System for Disabled Person to Escape a Building

(71) Applicant: Monti Marsters, Ailey, GA (US)

(72) Inventor: Monti Marsters, Ailey, GA (US)

(21) Appl. No.: 14/946,098

(22) Filed: Nov. 19, 2015

(51) Int. Cl. E06B 3/38; A62B 1/20; E06B 5/00

(52) U.S. Cl. CPC E06B 3/38; E06B 5/00; A62B 1/20; E05F 15/60

(57) ABSTRACT

A room, such as a bedroom, used by a disabled user is provided with a ramp-door installed within an opening in an exterior wall. The ramp-door opens to the outside. Embodiments intended for use on the first floor of a building open to contact the ground directly. Embodiments intended for use on upper floors of a building open to hang against the exterior wall. An overhead rail mounted within the room connects a fixed loading location to the opening of the ramp-door. An extension rail stored within the opening rotates into alignment with the overhead rail to place the rail terminus outside of the building a distance away from the exterior wall. A winch assembly may be driven along the overhead rail. The winch assembly supports a harness that may be raised and lowered, permitting a disabled user to access the outside and be lowered to ground level.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to escape systems for escaping from a building in an emergency and in particular to escape systems for assisting a disabled person in escaping from a building in an emergency. Many modern buildings are fitted with emergency exit features for egress in the event of a fire or other emergency. Exterior stairs and chutes are commonly built onto larger and taller buildings, while single family homes are often outfitted with one or more chain ladder that self-store within the sill or frame of one or more upper floor windows. Such facilities are crucial life-saving utilities for fully ambulatory people in an emergency, but can be difficult or impossible to use for disabled people. By contrast, disabled individuals caught in a fire or other emergency must typically wait for the assistance of a rescuer, who may or may not be able to safely carry the disabled individual through the provided escape facilities. In the case of wheelchair bound individuals who are able to self-propel, but who are caught in a large or tall building, the wheelchair bound individual may be forced to risk operating the building elevator in contravention of the posted warnings as the only practicable means of egress.

Disabled individuals would benefit from a suitable emergency escape system installed in rooms that they typically inhabit. For first floor rooms, a ramp-door installed in the wall would permit a wheelchair-bound or partially ambulatory person to escape to the exterior at ground level. For upper floor rooms, an a ramp-door combined with an overhead track supporting a winch and harness system would permit a disabled person to be transported from a fixed location in the room, such as a bed, to the outside and then lowered to safety at ground level.

### SUMMARY OF THE INVENTION

Accordingly, the invention is directed to an emergency escape system for a disabled person to escape a building. A room, such as a bedroom, that is frequently used by a disabled individual is provided with a ramp-door installed within an opening in an exterior wall. The ramp-door rotates out and down to provide an egress to the outside. The first exemplary embodiment, intended for use on the first floor of a building, opens to contact the ground at a gentle angle and provides guiderails to retain a wheelchair during a wheeled egress. The second exemplary embodiment, intended for use on upper floors of a building, opens to hang freely against the exterior wall. An overhead rail mounted within the room connects a fixed loading location such as a bed to the opening of the ramp-door. An extension rail stored within the opening rotates into alignment with the overhead rail to place the rail terminus outside of the building a distance away from the exterior wall. A winch assembly may be driven along the overhead rail. The winch assembly supports a harness that may be raised and lowered, permitting a disabled user to access the outside and be lowered to ground level.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 illustrates an interior perspective scene view of a first floor room in which the first exemplary embodiment is installed, and in which the ramp-door is in a closed state, showing the room interior 100, ramp-door 101, guiderails 102, wall-mounted control 103, exterior wall 104, and inside ramp-door opening 105.

FIG. 2 illustrates an exterior perspective scene view of a first floor room in which the first exemplary embodiment is installed, and in which the ramp-door is in a closed state, showing the ramp-door 101, exterior wall 104, building exterior 200, and outside ramp-door opening 201.

FIG. 3 illustrates an interior perspective scene view of a first floor room in which the first exemplary embodiment is installed, and in which the ramp-door is in an open state, showing the room interior 100, wall-mounted control 103, exterior wall 104, inside ramp-door opening 105, and wheelchair-bound user 300.

FIG. 4 illustrates an exterior perspective scene view of a first floor room in which the first exemplary embodiment is installed, and in which the ramp-door is in an open state, showing the ramp-door 101, guiderails 102, exterior wall 104, building exterior 200, outside ramp-door opening 201, and wheelchair-bound user 300.

FIG. 5 illustrates an interior perspective scene view of an upper-floor room in which the second exemplary embodiment is installed and in which the ramp-door is in a closed state, showing the room interior 500, wall-mounted control 503, exterior wall 504, inside ramp-door opening 505, bed 506, overhead rail 507, disabled user 508, harness 509, harness tether 510, winch assembly 511, harness storage position 513, and rail connection position 513.

FIG. 6 illustrates an exterior perspective scene view of an upper-floor room in which the second exemplary embodiment is installed, and in which the ramp-door is in a closed state, showing the ramp-door 501, exterior wall 504, building exterior 600, and outside ramp-door opening 601.

FIG. 7 illustrates an interior perspective scene view of an upper-floor room in which the second exemplary embodiment is installed, and in which the ramp-door is in an open state, showing the room interior 500, wall-mounted control 503, exterior wall 504, bed 506, overhead rail 507, disabled user 508, harness 509, harness tether 510, winch assembly 511, extension rail 700, harness storage position 512, rail connection position 513, and rail end position 701.

FIG. 8 illustrates an exterior perspective scene view of a first floor room in which the first exemplary embodiment is installed, and in which the ramp-door is in an open state, showing the ramp-door 501, exterior wall 504, disabled user 508, harness 509, harness tether 510, winch assembly 511, building exterior 600, outside ramp-door opening 601, extension rail 700, and rail end position 701.

FIG. 9 illustrates a cutaway portrait view of the ramp-door of the first exemplary embodiment, showing the ramp-door 101, first floor floorline 900, counterweight 901, ramp-door motor 902, and ramp-door axle 903.

FIG. 10 illustrates a cutaway portrait view of the ramp-door of the second exemplary embodiment, showing the ramp-door 501, extension rail 700, upper floor floorline 1000, counterweight 1001, ramp-door motor 1002, and ramp-door axle 1003.

FIG. 11 illustrates a cutaway profile view of the ramp-door of the first exemplary embodiment, showing the ramp-door 101, exterior wall 104, first floor floorline 900, and counterweight 901.

FIG. 12 illustrates a cutaway profile view of the ramp-door of the second exemplary embodiment, showing the ramp-door 501, exterior wall 504, extension rail 700, upper floor floorline 1000, and counterweight 1001.

FIG. 13 illustrates a portrait view of the winch assembly and harness of the second exemplary embodiment, showing the harness 509, harness tether 510, winch assembly 511, extension rail 700, user control 1300, lift pulley 1301, drive box 1302, drive wheel 1303, drive linkage 1304, non-spooled end 1305 of harness tether 510. And spooled end 1306 of harness tether 510.

### DETAILED DESCRIPTION OF THE INVENTION

Referring now to the invention in more detail, the invention is directed to an emergency escape system for a disabled person to escape a building. Generally, the invention is to be installed in a room, such as a bedroom, within a building, that has an outside wall. Embodiments directed both to first-floor rooms and to upper-floor rooms are described herein.

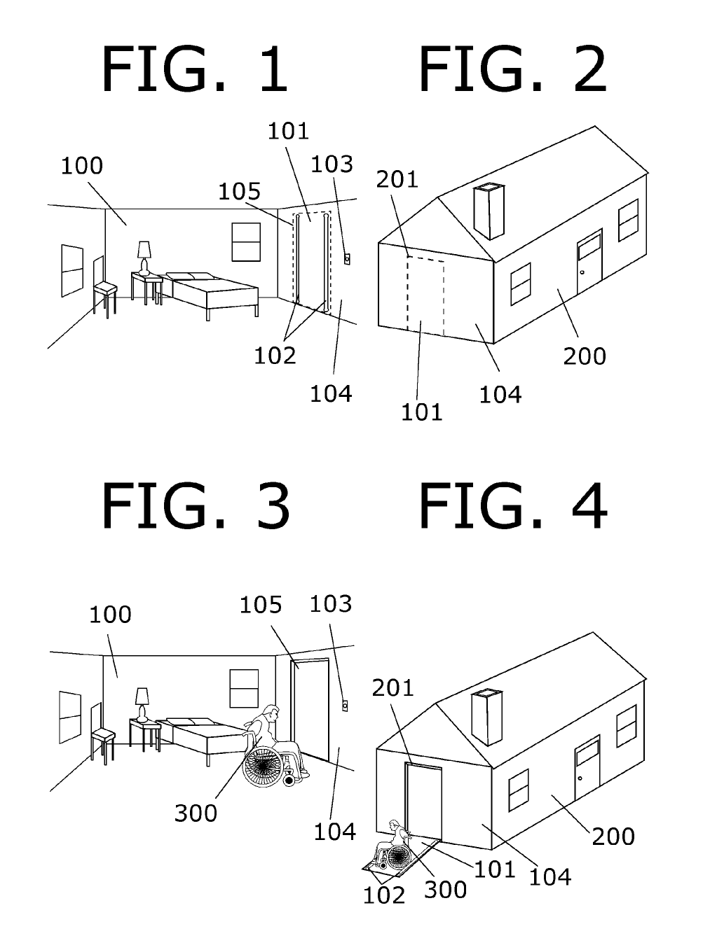

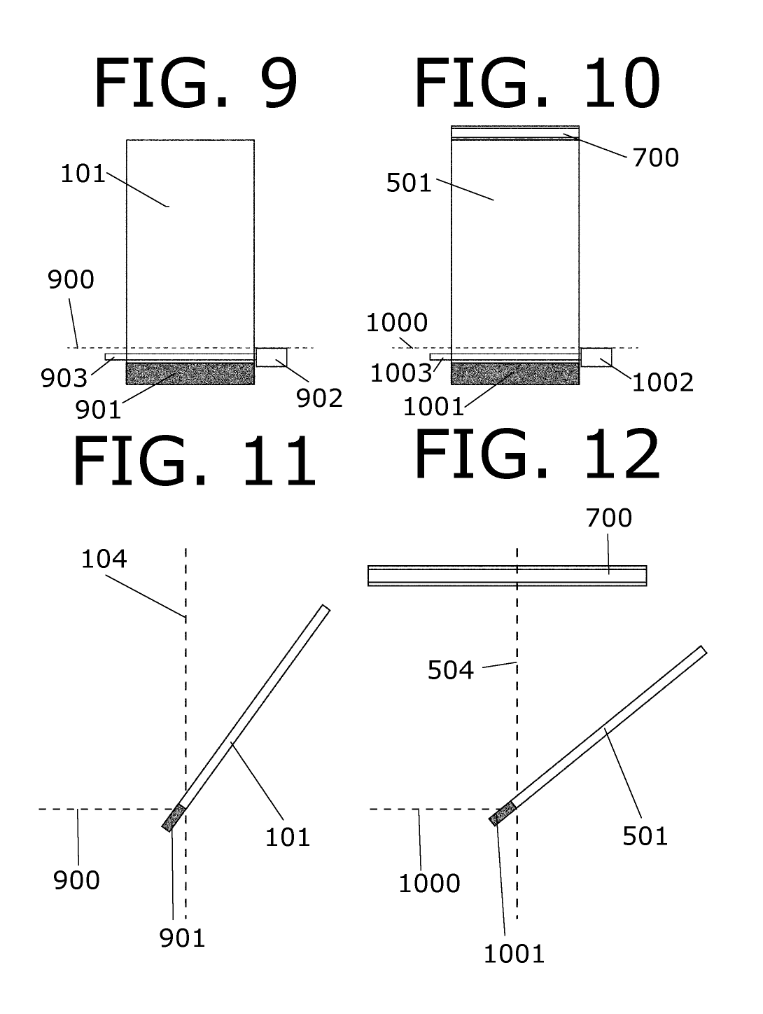

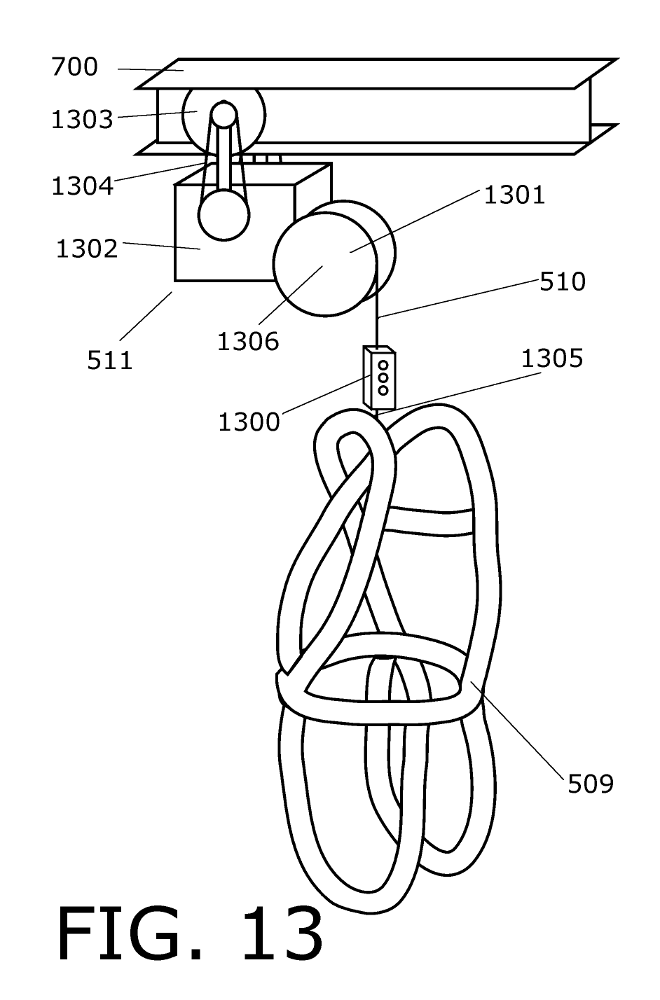

The first exemplary embodiment is intended for installation in first-floor rooms. An interior perspective scene of a room in which the first exemplary embodiment is installed is shown in FIG. 1. The room interior 100 as shown contains essentially standard furnishings for a residential bedroom, however the invention may be installed in essentially any room that is used by a disabled person, with all appropriate furnishings for the room's ordinary use. The room 100 has at least one exterior wall 104. FIG. 2 shows the exterior wall 104 in the context of the building exterior 200. Cut into the room interior 100 side of the exterior wall 104 and cleared of interior obstruction is an inside ramp-door opening 105, and correspondingly a matching outside ramp-door opening 201 is cut into the building exterior 200 side of the exterior wall 104, which is cleared of exterior obstruction. The inside ramp-door opening 105 may be framed in any manner appropriate to the material and architecture of the particular building; for example a standard residence constructed of wooden studs may have a door opening built into the framing in the manner of a standard exterior door. As shown in FIGS. 9 and 11, the inside ramp-door opening 105 and outside ramp-door opening 201 may extend below the floorline 900 of the first-floor room interior 100.

Referring still to the first exemplary embodiment, mounted within the ramp-door opening 105 is a ramp-door 101. The ramp door 101 is mounted rotatably about an axle 903 that is preferably located within the plane of the exterior wall 104 and below the floorline 900 of the first-floor room 100. The ramp-door may be driven on its axle 903 by an electric motor 902 with direct or indirect drive. A counterweight 901 may be placed in the base of the ramp-door 101 below the floorline 900. The ramp-door itself is constructed such that its exterior surface outwardly matches building 200 and that its interior surface outwardly matches that of the room interior 100. The interior surface of the ramp-door 101 is preferably made of a lightweight and durable material having sufficient sheer strength to support at least one adult human in a wheelchair, such as the wheel-chair bound user 300 of FIG. 3, traversing it. In one possible embodiment, where the invention is installed in a conventional home having interior drywall walls, an interior surface of plywood dressed in a finishing material with the appearance of drywall, such as plaster, may be used.

referring still to the first exemplary embodiment, the ramp-door 101 is preferably opened and closed selectively by a wall-mounted control 103. The wall-mounted control 103 may include any configuration of switches, buttons, or the like and may be linked to the electric motor 102 by direct wiring or by wireless link. The control need not be wall-mounted; one or more remote controls and optional multiple control points may be provided. A pair of guiderails 102 are mounted to the inside surface of the ramp door 101, preferably parallel to and near the vertical edges (the edges that are vertically oriented when the ramp-door is in a closed position); the guiderails extend upward preferably 4-6 inches, sufficient to retain on the ramp-door 101 the wheelchair-bound user 300 of FIG. 3 and prevent him from falling as he exits along the open ramp-door 101. The guiderails 102 may optionally be rotatably mounted so as to move between a first storage position and a second operational position. In such embodiments, the first storage position may be configured such that the guiderails appear to blend into the interior surface of the ramp-door 101. Automatic rotation may be accomplished by a direct or indirect electric drive motor or by mechanical interlink with the electric motor 902. Alternatively, the guiderails 102 may be spring-loaded such that they are urged into the second operational position, but are retained in place by a selectively releasable latch, which would be tied mechanically or electronically to the opening of the ramp-door 101.

To use the first exemplary embodiment, the wheelchair-bound user 300 or other user first identifies an emergency situation requiring egress of the building where the first exemplary embodiment invention is installed in a ground-floor room. Such a situation may be signaled by the activation of a smoke detector or other fire alarm system. The user activates the wall-mounted control 103 or alternative control and the ramp-door 103 opens, providing a safe and accessible egress to the outside, which the user may then traverse.

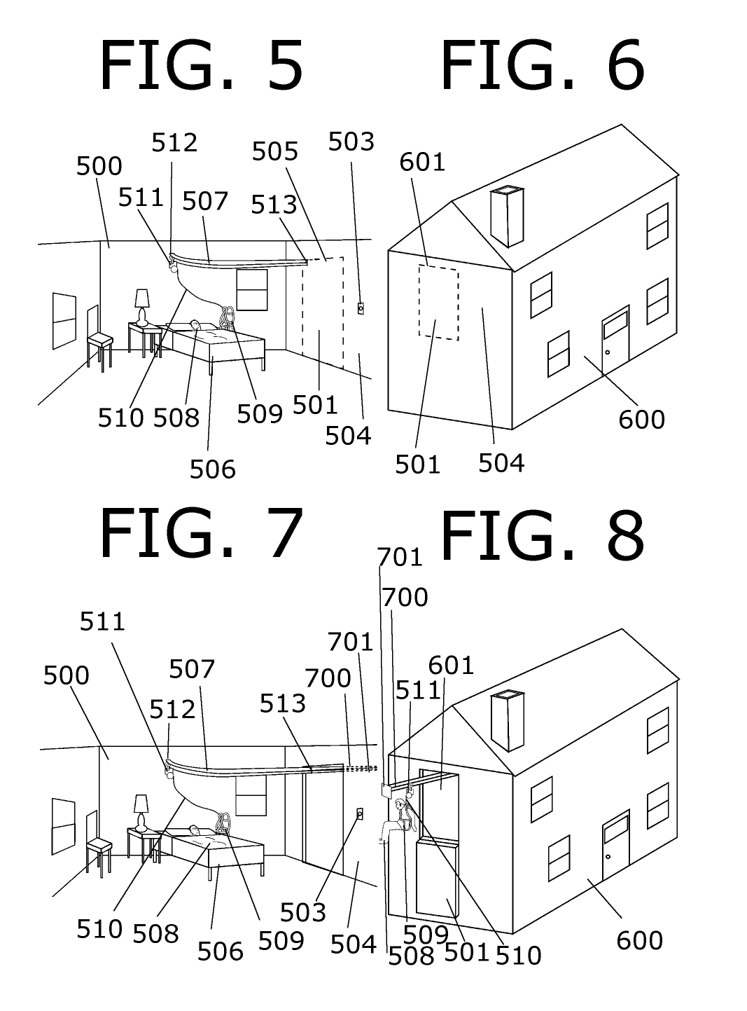

Referring now to the second exemplary embodiment, intended for installation on upper-floor room, FIG. 5 shows an interior perspective scene of a room in which the second exemplary embodiment is installed. Internally, the upper floor room interior 500, ramp-door 501, wall-mounted control 503, exterior wall 504, and inside ramp-door opening 505 correspond to the first floor room interior 100, ramp-door 101, wall-mounted control 103, exterior wall 104, and inside ramp-door opening 105 of the first exemplary embodiment. Externally, the ramp-door 501, exterior wall 504, building exterior 600, and outside ramp-door opening 601 correspond the first ramp-door 101, exterior wall 104, building exterior 200 and outside ramp-door opening 201 of the first exemplary embodiment, except that the ramp-door 501 of the second exemplary embodiment exhibits a wider range of motion than that of the first exemplary embodiment. Additionally the upper floor floorline 1000, counterweight 1001, electric motor 1002, and ramp-door axle 1003 of the second exemplary embodiment correspond in all respects to the first floor floorline 900, counterweight 901, and electric motor 902. The ramp door 501 of the second exemplary embodiment does not contact the ground to form a ramp and instead hangs against the building exterior 600 when fully open. The inside surface of the ramp-door 501 need not be traversed by a wheelchair bound user or other user, and so the second exemplary embodiment may lack a corresponding component to the guiderails 201 and also need not be reinforced or built differently than the surrounding interior 500 to support the weight of a traversing user.

Referring still to the second exemplary embodiment, the second exemplary embodiment provides a mode of rapid, accessible, and safe descent from an upper-floor. A disabled user 508 may don a harness 509 and be carried to the outside and lowered to the ground by the mechanism herein described. The harness 509 may be of any type and material suitable for safely and comfortably supporting the weight of an adult individual. The harness 509 is preferably easily worn by an individual with limited mobility. A bed 506, or other loading platform from which the disabled user may don the harness 509 and prepare an escape is provided. The harness 509 is linked to the non-spooled end 1305 of a harness tether 510, which is wound onto a lift pulley 1301, the lift pulley 1301 being a part of the winch assembly 511 and discussed in greater detail below. The spooled end 1306 of the harness tether 509 is securely fastened to the lift pulley 1301. The winch assembly moves back and forth along an overhead rail 507. The overhead rail 507 hangs from the ceiling or is otherwise rigidly affixed in an overhead position within the room interior and connects a harness storage position 512, preferably located near or over the bed 506 or other loading platform, with a rail connection position 513 located near the inside ramp-door opening 505. The overhead rail 507 is preferably a length of durable metal such as steel in an I-beam configuration. The overhead rail 507 need not be configured in a straight line, but may provide a curved track as shown with the degree of arc of any turn remaining within the reasonable turning radius of the particular hardware used in the winch assembly 511.

Between the inside ramp-door opening 505 and outside ramp-door opening 601, and above the top edge of the ramp-door is a rotatably mounted extension rail 700. The extension rail 700 may be rotated between a first storage position within the plane of the exterior wall 504 and a second operational position in line with the overhead rail 507. The second operational position of the extension rail 700 is such that the extension rail 700 extends from the rail connection position 513 to a track end position 701 outside through the inside ramp-door opening 505 and outside ramp-door opening 601 to a safe clearing distance away from the building exterior 600. The extension rail 700 is identical in construction to the overhead rail 507 and forms a minimal seam with the overhead rail 507 when in its second operation position. The extension rail may feature a stop structure at its distal end to occupy the rail end point 701; the stop structure may have any shape, size and strength sufficient to prevent the winch assembly 511 from rolling off the end. The extension rail 700 is optionally concealed on its interior and exterior sides to appear, in its first storage position, to blend into the building exterior 600 and upper-floor room interior 500. The extension rail 700 may be driven on its rotating mount by direct or indirect drive of an electric motor with electronic control, or by mechanical interlink with the electric motor 1002 that drives the ramp-door 501.

In addition to the wall-mounted control 503, the second exemplary embodiment may be controlled by the harness-wearing user from a user control 1300. The user control 1300 is preferably affixed to the harness tether 510 within reach of a harnessed user. The user control 1300 is preferably capable of sending wired or wireless control signals to open and close the ramp-door, move the winch assembly 511 back and forth along the overhead trail 507 and extension rail 700, and raise or lower the harness 509. The harness tether 510 is spooled on a lift pulley 1301, which is driven by direct or indirect drive from a motor within the drive box 1302. The lift pulley spins freely while mounted to the drive box 1302. The drive box 1302 is suspended from the axle of one or more drive wheels 1303, which are supported by the overhead rail 507 or extension rail 700 and roll freely back and forth along the overhead rail 507 or extension rail 700. At least one of the drive wheels 1303 is powered by indirect drive from a motor within the drive box 1302 via a drive linkage 1304 such as a chain.

To use the second exemplary embodiment, the disabled user 508 or other user first identifies an emergency situation requiring egress of the building where the first exemplary embodiment invention is installed in a ground-floor room. Such a situation may be signaled by the activation of a smoke detector or other fire alarm system. The user then proceeds to the bad 506 or other loading platform and dons the harness 509. The user then activates the user control 1300 to open the ramp-door 501, move the extension ail 700 into its second operational position, lift the harness 509 and himself up above the bed 506 or other loading platform, traverse the overhead rail 507 and extension rail 700 to a point outside that is clear of the building exterior 600, and lower the harness 509 and himself to the ground and safety.

Components, component sizes and materials listed above are preferable, but artisans will recognize that alternate components and materials could be selected without altering the scope of the invention.

While the foregoing written description of the invention enables one of .ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An emergency escape system for a disabled person to escape a building comprising:
(a) an exterior wall;
(b) a room interior;
(c) a building exterior;
(d) said room interior being in part bounded by said exterior wall;
(e) said building exterior being in part bounded by said exterior wall;
(f) an inside ramp-door opening;
(g) an outside ramp-door opening;
(h) said inside ramp-door opening being cut into said exterior wall on the face of said room interior;
(i) said outside ramp-door opening being cut into said exterior wall on the face of said building exterior;
(j) said inside ramp-door opening and said outside ramp-door opening being shaped and positioned to correspond with one another;
(k) a ramp-door;
(l) said ramp-door being of a size and shape to fit said outside ramp-door opening and said inside ramp-door opening
(m) a floorline;
(n) said floorline being located at the level of the floor of said room interior
(o) an axle;
(p) said axle being located below said floorline and between said inside rampdoor opening and said outside ramp-door opening;
(q) said ramp-door being fixedly mounted about said axle such that said axle and said ramp door rotate together;
(r) a ramp-door motor;
(s) said ramp-door motor being configured to rotate said axle;
(t) a ramp-door control;
(u) said ramp-door control being configured to control the operation of said ramp-door motor such that said ramp door motor may selectively drive said axle and said ramp-door to rotate between an open position and a closed position;
(v) a loading platform;
(w) said loading platform being located within said room interior;
(x) an overhead rail;
(y) said overhead rail located within room interior in an overhead position;
(z) said overhead rail being positioned to extend from a harness storage position with a rail connection position;
(aa) said harness storage position being located above said loading platform;
(bb) said rail connection position being located near said inside ramp-door opening;
(cc) an extension rail;
(dd) said extension rail being rotatably mounted between said outside ramp-door opening and said inside ramp-door opening, at a vertical level equal to that of said overhead rail;
(ee) said extension rail being configured to rotate between a first extension rail storage position and a second extension rail operational position;
(ff) said first extension rail storage position being such that said extension rail is positioned within said exterior wall;
(gg) a rail end position;
(hh) said second extension rail operational position being such that said extension rail extends from said rail connection position to said rail end position;
(ii) said rail end position being located outside of said outside ramp door opening;
(jj) a winch assembly;
(kk) one or more drive wheels;
(ll) said one or more drive wheels being rotatably mounted atop said winch assembly;
(mm) said winch assembly being suspended from one of said overhead rail or said extension rail, when said extension rail is in said second extension rail operational position, by said one or more drive wheels such that said winch assembly may be rolled freely back and forth between said harness storage position and said rail end position;
(nn) a drive box;
(oo) said drive box being affixed to said winch assembly;
(pp) said drive box being configured to provide mechanical drive to said one or more drive wheels;
(qq) a lift pulley;
(rr) said lift pulley being rotatably mounted to said winch assembly;
(ss) said drive box being configured to provide mechanical drive to said lift pulley;
(tt) a harness tether having a spooled end and a non-spooled end;
(uu) said harness tether being spooled about said lift pulley by said spooled end;
(vv) said harness being linked to said harness tether by the non-spooled end of said harness tether;
(ww) a user control;
(xx) said user control being affixed to said harness tether near said non-spooled end; and
(yy) said user control being configured to control the operation of said ramp-door motor such that said ramp door motor may selectively drive said axle and said ramp-door to rotate between an open position and a closed position, to control the operation of said extension rail such that said extension rail may be selectively moved between said first extension rail storage position and said second extension rail operational position, to control the operation of said one or more drive wheels such that said winch assembly may be selectively moved between said storage position and said rail end position, and to control the operation of said lift pulley such that said harness may be selectively raised or lowered.

2. The emergency escape system for a disabled person to escape a building of claim 1 further comprising a pair of guiderails, said guiderails being affixed to said rampdoor in a position and orientation that is parallel to and near the vertical edges of said ramp-door.

3. The emergency escape system for a disabled person to escape a building of claim 2
wherein said guardrails are rotatably mounted to said ramp-door such that said guardrails may be moved between a first storage position and a second operational position.

4. (canceled)
